(19) United States
(12) Patent Application Publication
(10) Pub. No.: US 2014/0139427 A1
(43) Pub. Date: May 22, 2014

(54) DISPLAY DEVICE

(71) Applicant: KABUSHIKI KAISHA TOSHIBA, TOKYO (JP)

(72) Inventors: RYUSUKE HIRAI, TOKYO (JP); NAO MISHIMA, TOKYO (JP); KENICHI SHIMOYAMA, TOKYO (JP); TAKESHI MITA, YOKOHAMA-SHI (JP)

(73) Assignee: KABUSHIKI KAISHA TOSHIBA, TOKYO (JP)

(21) Appl. No.: 14/082,416

(22) Filed: Nov. 18, 2013

(30) Foreign Application Priority Data
Nov. 20, 2012 (JP) 2012-253857

(51) Int. Cl. G06F 3/01

(52) U.S. Cl. CPC G06F 3/013
USPC 345/156

(57) ABSTRACT

A portable display device includes a display unit, a first capturing unit, and a second capturing unit. The display unit includes a rectangular display screen for displaying an image. The first capturing unit is configured to capture an image of an object. The first capturing unit is arranged in a region, corresponding to a first side of the display screen, which is a part of a peripheral region of the display unit other than the display screen. The second capturing unit is configured to capture an image of the object. The second capturing unit is arranged in a region, corresponding to a second side adjacent to the first side, which is a part of the peripheral region.

### CROSS-REFERENCE TO RELATED APPLICATION

This application is based upon and claims the benefit of priority from Japanese Patent Application No. 2012-253857, filed on Nov. 20, 2012, the entire contents of which are incorporated herein by reference.

### FIELD

Embodiments described herein relate generally to a portable display device.

### BACKGROUND

Conventionally, a technique is known where cameras are arranged in regions, in the peripheral region of a display device other than a display screen, corresponding to two opposite sides of a rectangular display screen (two sides extending in the same direction), where a line-of-sight direction is detected based on face images of a viewer captured by the two cameras, and where the display position of an image is changed according to the detected line-of-sight direction.

A case of applying the conventional technique described above to a mobile terminal (for example, a tablet terminal) is considered. In this case, if a viewer holds the mobile terminal at positions where the cameras are arranged on the mobile terminal, the hands of the viewer block the cameras, and images to be captured by the cameras are not obtained.

Accordingly, the viewer has to be careful, at the time of holding the mobile terminal, not to hold the positions where the cameras are arranged. That is, there are certain restrictions on the positions where the viewer can hold the mobile terminal, and there is a problem that the convenience of the viewer is reduced.

### BRIEF DESCRIPTION OF THE DRAWINGS

FIG. 1 is an external view of a display device of an embodiment;

FIG. 2 is a diagram illustrating an example configuration of the display device of the embodiment;

FIG. 3 is a schematic view of an optical element in a state where the display device of the embodiment is horizontally placed;

FIG. 4 is a schematic view of the optical element in a state where the display device of the embodiment is vertically placed;

FIG. 5 is a diagram illustrating an example functional configuration of a control unit of the embodiment;

FIG. 6 is a diagram, illustrating a three-dimensional coordinate system of the embodiment;

FIG. 7 is a diagram illustrating examples of a search window and a width of a target object of the embodiment;

FIG. 8 illustrates an example of controlling a visible area of the embodiment;

FIG. 9 illustrates an example of controlling a visible area of the embodiment;

FIG. 10 illustrates an example of controlling a visible area of the embodiment; and

FIG. 11 is a flow chart illustrating an example of a process of a first determination unit of the embodiment.

### DETAILED DESCRIPTION

According to an embodiment, a portable display device includes a display unit, a first capturing unit, and a second capturing unit. The display unit includes a rectangular display screen for displaying an image. The first capturing unit is configured to capture an image of an object. The first capturing unit is arranged in a region, corresponding to a first, side of the display screen, which is a part of a peripheral region, of the display unit other than the display screen. The second capturing unit is configured to capture an image or the object. The second capturing unit is arranged in a region, corresponding to a second side adjacent to the first side, which is a part of the peripheral region.

Hereinafter, an embodiment of a display device according to the present invention will be described in detail with reference to the appended drawings.

A display device of the present embodiment is a portable stereoscopic image display device (typically, a tablet stereoscopic image display device) with which a viewer can view a stereoscopic image without glasses, but this is not restrictive. A stereoscopic image is an image including a plurality of parallax images having a parallax to one another. A parallax is a difference in view due to being seen from different directions. Additionally, an image in the embodiment may be a still image or a moving image.

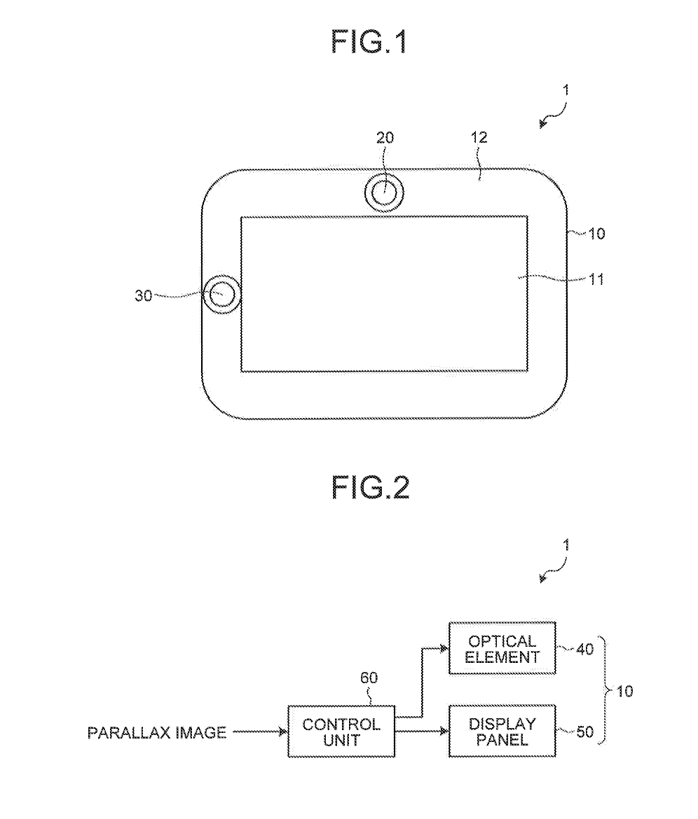

FIG. 1 is an external view of a display device 1 of the present embodiment. As illustrated in FIG. 1, the display device 1 includes a display unit 10, a first capturing unit 20, and a second capturing unit 30.

The display unit 10 includes a rectangular display screen 11 for displaying an image. In the present embodiment, the shape of the display screen is rectangular, and the size is about seven to ten inches, but this is not restrictive. In the following description, the long side of the display screen will be referred to as a first side, and the short side will be referred to as a second side. That is, in this example, the long side of the rectangular display screen corresponds to a “first side”, and the short side corresponds to a “second side”, but this is not restrictive.

The first capturing unit 20 is arranged in a region corresponding to the first side, in a peripheral region 12 of the display unit 10 other than the display screen 11. Additionally, the number of the first capturing units 20 to be arranged in the region corresponding to the first side in the peripheral region 12 is arbitrary, and two or more first capturing units 20 may be arranged, for example. Furthermore, the second capturing unit 30 is arranged in a region, in the peripheral region 12, corresponding to the second side. Additionally, the number of the second capon ring units 30 to be arranged in the region corresponding to one second side in the peripheral region is arbitrary, and two or more second capturing units 30 may be arranged, for example. In the following description, an image captured by the first capturing unit 20 or the second capturing unit 30 will sometimes be referred to as a captured image, and a target object such as the face of a person, for example, included in the captured, image will be sometimes referred, to as an object. Also, if the first capturing unit 20 and the second capturing unit 30 are not to be distinguished from each other, they may be simply referred to as capturing unit(s). The first capturing unit 20 and the second capturing unit 30 may each be formed from various known capturing devices, and may be formed from, a camera, for example.

FIG. 2 is a block diagram illustrating an example configuration of the display device 1. As illustrated in FIG. 2, the display device 1 includes a display unit 10 including an optical element 40 and a display panel 50, and a control unit 60. A viewer may perceive a stereoscopic image displayed, on the display panel 50 by observing the display panel 50 via the optical element 40.

The refractive index profile of the optical element 40 changes according to an applied voltage. A light beam entering the optical element 40 from the display panel 50 is emitted in a direction according to the refractive index profile of the optical element 40. In the present embodiment, an example is shown where the optical element 40 is a liquid crystal GRIN (gradient index) lens array, but this is not restrictive.

The display panel 50 is provided at the back side of the optical element 40, and displays a stereoscopic image. For example, the display panel 50 may be configured in a known manner where subpixels of RGB colors are arranged in a matrix with RGB in one pixel, for example. A pixel included in a parallax image according to a direction of observation via the optical element 40 is assigned to each pixel of the display panel 50. Here, a set of parallax images corresponding to one optical aperture (in this example, one liquid crystal GRIN lens) is called an element image. The element image may be assumed to be an image that includes pixels of each parallax image. Light emitted from each pixel is emitted in a direction according to the refractive index profile of a liquid crystal GRIN lens formed in accordance with the pixel. The arrangement of subpixels of the display panel 50 may be other known arrangements. Also, the subpixels are not limited to the three colors of RGB. For example, four colors may be used instead.

The control unit 60 performs control of generating a stereoscopic image which is a set of element images based on a plurality of parallax images which have been input, and displaying the generated stereoscopic image on the display panel 50.

Also, the control unit 60 controls the voltage to be applied to the optical element 40. In the present embodiment, the control unit 60 switches between modes indicating states of voltage to be applied to the optical element 40, according to the attitude of the display device 1. Here, as the examples of the modes, there are a first mode and a second mode. In the present embodiment, if the display device 1 is horizontally placed (or is nearly horizontally placed) the control unit 60 performs control of setting the first mode, and if the display device 1 is vertically placed (or is nearly vertically placed), the control unit 60 performs control of setting the second mode. However, this is not restrictive, and the types and the number of modes may be set arbitrarily.

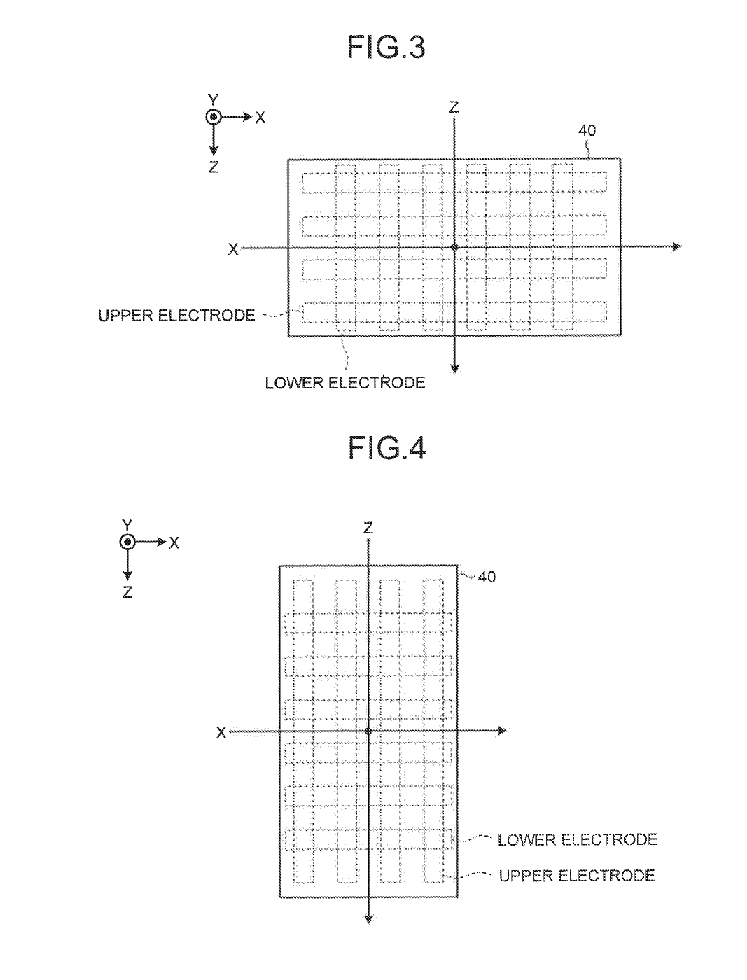

FIG. 3 is a plan view schematically illustrating the optical element 40 in a state where the vertical direction (the up-down direction) is set as the Z-axis, the left-right direction orthogonal to the Z-axis is set as the X-axis, and the front-back direction orthogonal to the X-axis is set as the Y-axis, and where the display device 1 is horizontally placed (the display device 1 is placed on the XZ plane such that the long side of the display screen 11 is parallel to the X-axis direction). In the example in FIG. 3, the center of she surface of the optical element 40 is set as the origin. Although the details are not illustrated in the drawing, the optical element 40 is formed from a pair of opposite transparent, substrates, and a liquid crystal layer disposed between the pair of transparent substrates, and a plurality of electrodes are periodically arranged on each of the transparent substrate on the upper side and the transparent substrate on the lower side. Here, the electrodes are arranged such that the extending direction of each of the plurality of electrodes formed on the upper transparent substrate (sometimes referred to as “upper electrode(s)”) and the extending direction of each of the plurality of electrodes formed on the lower transparent substrate (sometimes referred to as “lower electrode(s)”) are orthogonal.

In the example in FIG, 3, the extending direction of the lower electrodes is parallel to the Z-axis direction, and the extending direction of the upper electrodes is parallel to the X-axis direction. In this example, when the first, mode is set, the control unit 60 controls the voltage to be applied to the upper electrodes to be a reference voltage (for example, 0 V) so that the liquid crystal GRIN lenses are periodically arranged along the X-axis direction with the ridge line direction of each lens extending in parallel to the Z-axis direction, and also separately controls each voltage to be applied to the lower electrodes. That is, in the first mode, the lower electrodes function as a power plane, while the upper electrodes function as a ground plane.

On the other hand, FIG. 4 is a plan view schematically illustrating the optical element 40 in a state where the display device 1 is vertically placed (the display device 1 is placed on the XZ plane such that the short side of the display screen 11 is parallel to the X-axis direction). FIG. 4 may also be said to be a schematic view where the optical element 40 is rotated, on the XZ plane, 90 degrees from the state illustrated in FIG. 3 around the origin. In the example in FIG. 4, the extending direction of the upper electrodes is parallel to the Z-axis direction, and the extending direction of the lower electrodes is parallel to the X-axis direction. In this example, when the second mode is set, the control unit 60 controls the voltage to be applied, to the lower electrodes to be reference voltage (for example, 0 V) so that the liquid crystal GRIN lenses are periodically arranged along the X-axis direction with the ridge line direction of each lens extending in parallel to the Z-axis direction, and also separately controls each voltage to be applied to the upper electrodes. That is, in the second mode, the upper electrodes function as a power plane, while the lower electrodes function as a ground plane. By switching the roles of the upper electrodes and the lower electrodes that are orthogonal (the role as a power plane or a ground, plane), horizontal/vertical switching display may be realized.

Additionally, the configuration of the optical element 40 is arbitrary, and is not limited to the configuration described above. For example, a configuration may be adopted where an active barrier capable of switching between on and off to perform a lens function for horizontal placement, and an active barrier capable of switching between on and off to perform a lens function for vertical placement are overlapped. Also, the optical element 40 may be arranged with the extending direction of the optical aperture (for example, the liquid crystal GRIN lens) tilted to a predetermined degree with respect to the column direction of the display panel 50 (a configuration of a tilted lens).

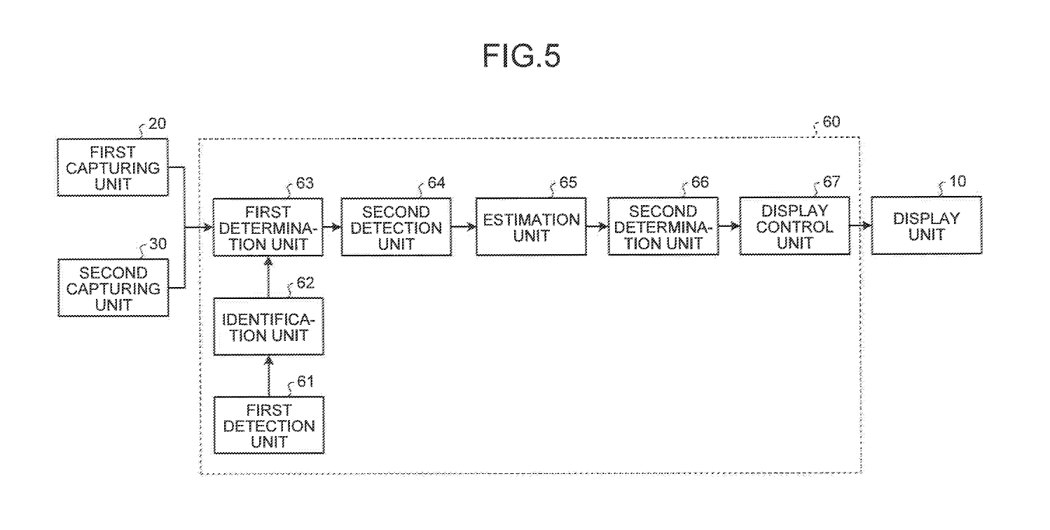

FIG. 5 is a block diagram, illustrating an example functional configuration of the control unit 60. As illustrated in FIG. 5, the control unit 60 includes a first detection unit 61, an identification unit 62, a first determination unit 63, a second detection unit 64, an estimation unit 65, a second determination unit 66, a ad a display control unit 67. Additionally, the control unit 60 also includes a function of controlling voltage to be applied to the electrodes of the optical element 40, and a function of controlling the vertical/horizontal switching display, but these functions will be omitted from the drawings and the description.

The first detection unit 61 detects the attitude of the display device 1. In the present embodiment, the first-detection unit 61 is formed from a gyro sensor, but this is not restrictive. The first detection unit 61 takes vertical downward as the reference, and detects a relative angle (an attitude angle) of the display device 1 with respect to the vertical downward, as the attitude of the display device 1. In this example, the rotation angle of an axis in the vertical direction (the up-down axis) is referred to as a yaw angle, the rotation angle of an axis in the left-right direction (a left-right axis) orthogonal to the vertical direction is referred to as a pitch angle, and the rotation angle of an axis in the front-back direction (a front-back axis) orthogonal to the vertical direction is referred to as a roll angle, and the attitude (the tilt) of the display device 1 may be expressed by the pitch angle and the roll angle. The first detection unit 61 detects the attitude of the display device 1 at a periodic cycle, and outputs the detection result to the identification unit 62.

The identification unit 62 identifies a first direction indicating the extending direction of the first side mentioned above (the long side of the display screen 11) and a second direction indicating the extending direction of the second side mentioned above (the short side of the display screen 11) based on the attitude of the display device 1 detected by the first detection unit 61. Every time information about the attitude of the display device 1 is received from the first detection unit 61, the identification unit 62 identifies the first direction and the second direction, and outputs information about the first direction and the second direction which have been identified to the first determination unit 63.

In the case a first angle indicating an angle between a reference line indicating a line segment connecting the eyes of a viewer, which are objects, and the first direction identified by the identification unit 62 is smaller than a second angle between the reference line and the second direction identified by the identification unit 62, the first determination unit 63 determines the first capturing unit 20 as at least one capturing unit to be used for capturing an object. When the first angle is smaller than the second angle, it can be assumed that the long side of the display screen 11 is more parallel to the line segment connecting the eyes of the viewer than the short side of the display screen 11, and that the viewer is using the display device 1 holding a region, in the peripheral region 12, corresponding to the short side of the display screen 11 (i.e., it can be assumed that the display device 1 is being used, being placed nearly horizontally). Accordingly, by capturing an object by the first, capturing unit 20 arranged in a region, in the peripheral region 12, corresponding to the long side, it is possible to keep capturing the viewer regardless of the position of the display device 1 the viewer is holding.

Furthermore, in the case the second angle described above is smaller than the first angle described above, the first determination unit 63 determines the second capturing unit 30 as at least one capturing unit to be used for capturing an object. When the second angle is smaller than the first angle, it can be assumed that the short side of the display screen 11 is more parallel to the line segment connecting the eyes of the viewer than the long side of the display screen 11, and that the viewer is using the display device 1 holding a region, in the peripheral region 12, corresponding to the long side of the display screen 11 (i.e. it can be assumed that the display device 1 is being used, being placed nearly vertically). Accordingly, by capturing an object by the second capturing unit 30 arranged in a region, in the peripheral, region 12, corresponding to the short side, it is possible to keep capturing the viewer regardless of the position of the display device 1 the viewer is holding.

Moreover, before performing the determination process described above, the first determination unit 63 identifies the reference line. More specifically, the first determination unit 63 acquires a captured image of each of the first capturing unit 20 and the second capturing unit 30, and performs detection of a face image of the viewer using the acquired captured images. Various known techniques may be used as the method of detecting the face image. Then, the reference line indicating the line segment between the eyes of the viewer is identified from the face image detected. Additionally, this is not restrictive, and the method of identifying the reference line is arbitrary. For example, a reference line indicating the line segment connecting the eyes of a viewer may be set in advance, and the reference line set in advance may be stored in a memory not illustrated. In this case, the first determination unit 63 may identify the reference line before performing the determination process described above, by accessing the memory not illustrated. Likewise, a reference line set in advance may be held in an external server device, and the first determination unit 63 may identify the reference line before performing the determination process described above, by accessing the external server device.

The captured image of the first, capturing unit 20 or the second capturing unit 30 determined by the first determination unit 63 is output to the second detection unit 64. The second detection unit 64 uses the captured image determined by the first determination unit 63, and performs a detection process of detecting whether or not an object is present in the captured image. Then, in the case an object is detected, the second detection unit 64 outputs object position information indicating the position and the size of the object in the captured image to the estimation unit 65,

In the present embodiment, the second detection unit 64 scans, by a search window of a predetermined size, the captured image of the capturing unit determined by the first determination unit 63 from the first capturing unit 20 and the second capturing unit 30, and evaluates the degree of similarly between a pattern of an image of the object prepared in advance and a pattern of an image in the search window, to thereby determine whether the image in the search window is the object. For example, in the case a target object is the race of a person, a search method disclosed in Paul Viola and Michael Jones, Rapid Object Detection using a Boosted Cascade of Simple Features, 2001 IEEE Computer Society Conference on Computer vision and Pattern Recognition (CVPR 2001) may be used. This search method is a method of obtaining a plurality of rectangle features with respect to an linage in a search window, and determining whether there is a frontal face using a strong classifier which is a cascade of weak classifiers for respective features, but the search method is not limited to such, and various known techniques may be used.

The estimation unit 65 estimates the three-dimensional position of the object in the real space based on the object, position information detected by the detection process of the second detection unit 64 and. indicating the position and the size of the object. At this time, it is preferable that the actual size in. the three-dimensional space of the object is known, but an average size may also be used. For example, according to statistical data, the average width of the face of an adult is 14 cm. Transformation from the object position information to a three-dimensional position (P, Q, R) is performed based on a pin-hole camera model.

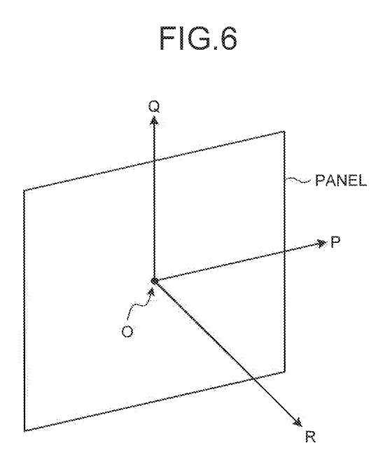

Additionally, in this example, a three-dimensional coordinate system in the real space is defined as follows. FIG. 6 is a schematic view illustrating the three-dimensional coordinate system, in the present embodiment. As illustrated in FIG. 6, in the present embodiment, the center of the display panel 50 is given as an origin O, and a P-axis is set to the horizontal direction, of the display screen, a Q-axis is set to the vertical, direction of the display screen, and an R-axis is set to the normal direction of the display screen. However, the method of setting the coordinates in the real space is not restricted to the above. Also, in this example, the top left of a captured image is given as the origin, and an x-axis which is positive in the horizontal right direction, and a y-axis which is positive in the vertical downward direction are set.

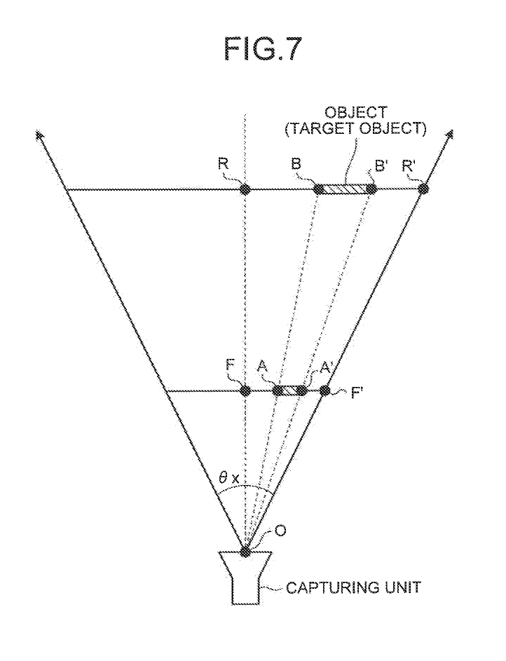

FIG. 7 is a diagram illustrating a search window, formed from the P-axis and the R-axis, for an object detected on a PR plane, and the width in the real space of an object on the P-axis. The angle of view in the P-axis direction of the capturing unit (the first capturing unit 20 or the second capturing unit 30) determined by the first determination unit 63 is given as θx, the focal position in the R-axis direction of a captured image obtained by the capturing unit is given as F, and the position in the R-axis direction of the object is given as R. Then, with respect to AA′, BB′, OF, and OR in FIG. 7, the relationship of AA′:BB′=OF:OR is established based on the scaling relationship. Additionally, the AA′ indicates the width in the P-axis direction of the search window in the captured image of the capturing unit. The BB′ indicates the actual width of the object in the P-axis direction. The OF indicates the distance from the capturing unit to the focal position F. The OR indicates the distance from the capturing unit to a position R of the object.

Here, FF′, which is the distance between the focal position F and an end portion of the captured image is given as wc/2, which is half the horizontal resolution of a monocular camera (the capturing unit). Then, OF=FF′/tan (θₓ/2) is established.

Then, the AA′, which is the width in the P-axis direction of the search window in the captured image, is made the number of pixels of the search window in the x-axis direction. The BB′ is the actual width of the object in the P-axis direction, but an average size of the object is assumed. For example, in the case of a face, the average width of a face is said to be 14 cm.

Then, the estimation unit 65 obtains the OR, which is the distance from the capturing unit to the object, by the following Equation (1).

$$OR = \frac{{BB}^{′} \times OF}{{AA}^{′} } \qquad ( 1 )$$

That is, the estimation unit 65 may estimate the R coordinate of the three-dimensional position of the object based on the width indicated by the number of pixels of the search window in the captured image. Also, with respect to AF, BR, OF, and OR in FIG. 7, the relationship of AF:BR=OF:OR is established based on the scaling relationship. The AF indicates the distance between an end portion A in the P-axis direction of the search window in the captured image and the focal position F. Also, the BR indicates the distance between an end portion B of the object in the P-axis direction and the position R of the object in the P-axis direction.

Accordingly, the estimation unit 65 estimates the P coordinate of the three-dimensional position of the object by obtaining the BR. Then, the estimation unit 65 estimates the Q coordinate of the three-dimensional position of the object in the same manner with respect to the QR plane.

Referring back to FIG. 5, a description will be given. Here, before giving a specific description about the second determination unit 66 and she display control unit 67, methods of setting a visible area and of controlling a setting range will be described. The position of a visible area is decided based on the combination of display parameters of the display unit 10. As the display parameters, there are a shift of a displayed image, the distance (the gap) between the display panel 50 and the optical element 40, the pitch between pixels, rotation, change in shape, and movement of the display unit 10, and the like,

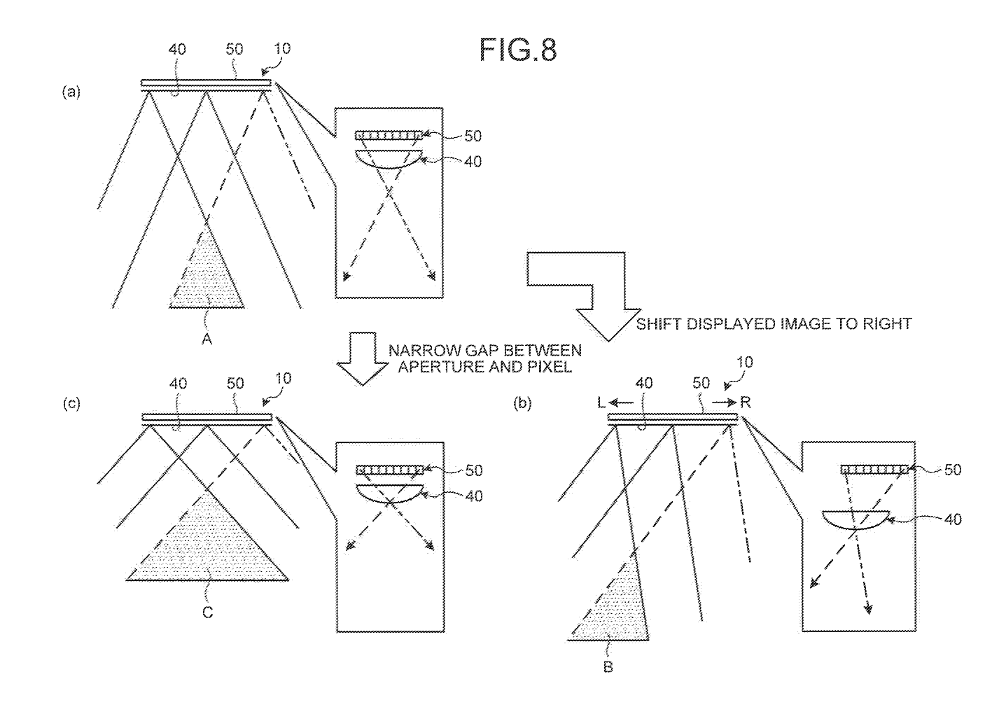

FIGS. 8, 9, and 10 illustrate the set position of a visible area or control of the setting range. First, referring to FIG. 8, a case of controlling the position where a visible area is to be set and the like by adjusting a shift of the displayed image or the distance (the gap) between the display panel 50 and the optical element 40 will be described. In FIG. 8. when a displayed image is shifted in the right direction (see direction of arrow R in (b) of FIG. 6), light beams are shifted in the left direction (direction of arrow L in (b) of FIG. 8), and thus, the visible area moves in the left direction (see a visible area B in (b) of FIG. 8), On the other hand, if the displayed image is moved more in the left direction compared to (a) of FIG. 8, the visible area moves in the right direction (not illustrated).

Also, as illustrated in (a) and (c) of FIG. 8, the visible area may be set at a position closer to the display unit 10 as the distance between the display panel 50 and the optical element 40 becomes smaller. Additionally, the density of light beams becomes lower as the visible area is set to a position closer to the display unit 10. Also, the visible area may be set at a position farther from the display unit 10 as the distance between the display panel 50 and the optical element 40 becomes greater.

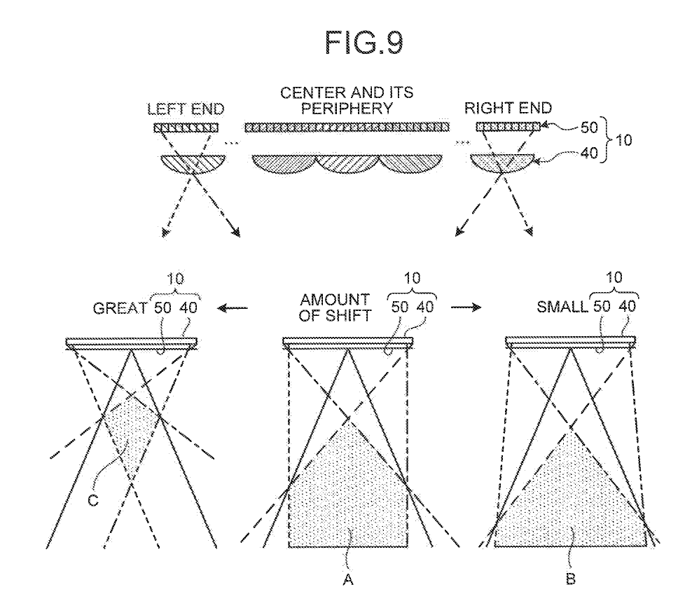

A case of controlling the position at which the visible area is to be set and the like by adjusting the alignment (pitch) of pixels displayed on the display panel 50 will be described, with reference to FIG. 9. The visible area may be controlled, using the fact that the positions of the optical element 40 and the pixels are shifted relatively greatly at the right end or the left end of the screen of the display panel 50. When the amount of relative shift, between the positions of the pixels and the optical element 40 is increased, the visible area is changed from a visible area A to a visible area C illustrated in FIG. 9. On the other hand, if the amount of relative shift between the positions of the pixels and the optical element 40 is reduced, the visible area changes from the visible area A to a visible area 3 illustrated in FIG. 9. Additionally, the maximum length of width of the visible area, (the maximum length of the visible area in the horizontal direction) is referred to as a visible area setting distance.

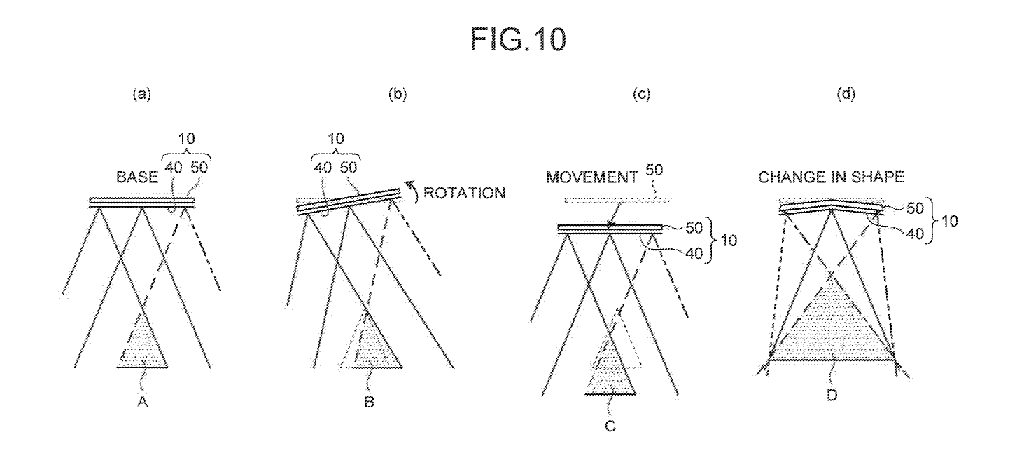

A case of controlling a position at which the visible area, is to be set and the like by the rotation, change in shape or movement of the display unit 10 will be described with reference to FIG. 10. In FIG. 10, (a) illustrates a basic state of the display unit 10. As illustrated in (b) of FIG. 10, a visible area A in the basic state may be changed to a visible area B by rotating the display unit 10. Also, as illustrated in (c) of FIG. 10, the visible area A in the basic state may be changed to a visible area C by moving the display unit 10. Furthermore, as illustrated in (d) of FIG. 10, the visible area A in the basic state may be changed to a visible area D by changing the shape of the display unit 10. As described above, the position of the visible area is decided by the combination of display parameters of the display unit 10.

Referring back to FIG. 5, a description will be given. The second, determination unit 66 determines a visible area so as to include the three-dimensional position estimated by the estimation unit 65 described, above. A more specific description is given below. The second determination unit 66 calculates visible area information indicating a visible area where a stereoscopic image may be viewed from a three-dimensional position estimated by the estimation unit 65. To calculate the visible area information, pieces of visible area information indicating visible areas corresponding to combinations of display parameters are scored in a memory (not illustrated) in advance, for example. Then, the second determination unit 66 calculates the visible area information by searching, from the memory, for viewing information which includes the three-dimensional position acquired from the estimation unit 65 in the visible area.

Additionally, the determination method of the second determination unit 66 is arbitrary, and is not limited to the method described above. For example, the second determination unit 66 may also determine the position of a visible area including the three-dimensional position estimated by the estimation unit 65, by arithmetic operation. In this case, for example, three-dimensional coordinate values and an arithmetic expression for obtaining a combination of display parameters for determining the position of a visible area which includes the three-dimensional coordinate values are stored in a memory (not illustrated) in association. Then, the second determination unit 66 reads an arithmetic expression corresponding to the three-dimensional position (the three-dimensional coordinate values) estimated by the estimation unit 65 from the memory and obtains a combination of display parameters using the arithmetic expression read out, to thereby determine the position of a visible area which includes the three-dimensional coordinate values.

The display control unit 67 performs display control of controlling the display unit 10 such that a visible area is formed at a position determined by the second determination unit 66. More specifically, the display control unit 67 controls the combination of display parameters of the display unit 10. A stereoscopic image whose visible area includes a region including the three-dimensional position of an object estimated by the estimation unit 65 is thereby displayed on the display unit 10.

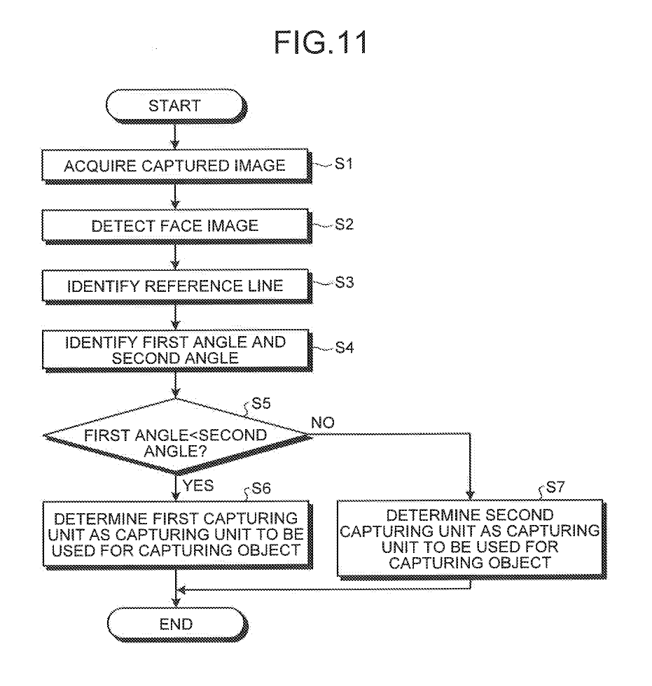

Next, a determination process of the first determination unit 63 will be described with reference to FIG. 11. FIG. 11 is a flow chart illustrating an example of a determination process of the first determination unit 63. First, the first determination unit 63 acquires a captured image from each of the first capturing unit 20 and the second capturing unit 30 (step S1). Then, the first determination unit 63 detects a face image of a viewer using the captured images acquired in step S1 (step S2). Then, the first determination unit 63 identifies a reference line indicating the line segment between the eyes of the viewer from the face image defected in step S2 (step S3). Next, the first determination unit 63 identifies, from pieces of information indicating the first direction (the direction of the long side of the display screen 11) and the second direction (the direction of the short side of the display screen 11) output from the identification unit 62, and the reference line identified in step S3, the first angle indicating the angle between the first direction and the reference line and the second angle indicating the angle between the second direction and the reference line (step S4).

Next, the first determination unit 63 determines whether or not the first angle is smaller than the second angle (step S5). In the case the first angle is determined to be smaller than the second angle (step S5: YES), the first determination unit 63 determines the first capturing unit 20 as the capturing unit to be used for capturing an object (step S6). On the other hand, in the case the second angle is determined to be smaller than the first angle (step S5; NO), the first determination unit 63 determines the second, capturing unit 30 as the capturing unit to be used for capturing an object (step S7).

It may be assumed here that, with a portable display device capable of vertical/horizontal switching display as in the present embodiment, a viewer holds a region, in the peripheral region 12, corresponding to the short side to use the display device which is horizontally placed, and holds a region, in the peripheral region 12, corresponding to the long side to use the display device which, is vertically placed. With a conventional configuration where a camera is arranged, only in a region, in the peripheral region 12, corresponding to the short side or the long side of the rectangular display screen, a viewer has to be careful at the time of switching the use state of the display device from horizontal placement to vertical placement or from vertical placement to horizontal placement not to hold a position where the camera is arranged, and a problem that the convenience of a user is reduced is significant.

Accordingly, as described above, in the present embodiment, the first capturing unit 20 is arranged in the region, in the peripheral region 12 of the display unit 10, corresponding to the first side of the display screen 11 (in this example, the long sloe of the oblong display screen), and the second capturing unit 30 is arranged in the region, in the peripheral region 12, corresponding to the second side (in this example, the shore side of the oblong display screen 11). Accordingly, for example, in the case a viewer uses the display device 1 holding the region, in the peripheral region 12, corresponding to the first side of the display screen 11, the second capturing unit 30 arranged in the region, in the peripheral region 12, corresponding to the second side adjacent to the first side (extending in a different direction) of she display screen 11 is not blocked by the hand of the viewer. That is, no matter where in the region, in the peripheral region 12, corresponding to the first side the viewer is holding, it is possible to keep capturing the viewer using the second capturing unit 30. Also, for example, in the case the viewer uses the display device 1 holding the region, in the peripheral region 12, corresponding to the second side of the display screen 11, the first capturing unit 20 arranged in the region, in the peripheral region 12, corresponding to the first side adjacent to the second side of the display screen 11 is not blocked by the hand of the viewer. Accordingly, no matter where in the region, in the peripheral region 12, corresponding to the second side the viewer is holding, it is possible to keep capturing the viewer using the first capturing unit 20. That is, according to the present embodiment, the restriction regarding the position of the display device 1 to be held by the viewer is reduced, and the convenience of the viewer is increased.

Furthermore, as described above, a portable stereoscopic image display device estimates the three-dimensional position of a viewer based on a captured image in which the viewer is included, and performs control of determining a visible area in such a way that the estimated three-dimensional position of the viewer is included therein (referred, to as “visible area control”), and thus, the viewer is enabled to view a stereoscopic image without changing his/her position to be in the visible area. The viewer has to be captured, to perform this visible area control, and if the hand of the viewer holding the display device 1 blocks the camera (the capturing unit), a problem arises that capturing of the viewer is not performed and the visible area control is not appropriately performed.

In contrast, according to the present embodiment, since the viewer switches the use state of a stereoscopic image display device from horizontal placement to vertical placement or from vertical placement to horizontal placement, capturing of the viewer may be continued, no matter now the position by which the stereoscopic image display device is held, is changed, and thus, a beneficial effect that appropriate visible area control may be performed while increasing the convenience of the viewer may be achieved.

Additionally, the control unit 60 of the embodiment described above has a hardware configuration where a CPU (Central Processing Unit), a ROM, a RAM, a communication I/F device and the like are included. The function of each of the units described, above (the first detection unit 61, the identification unit 62, the first determination unit 63, the second detection unit 64, the estimation unit 65, the second determination unit 66, and the display control unit 67) is realized by the CPU utilizing the RAM, and executing programs stored in the ROM. Moreover, this is not restrictive, and at least one or some of the functions of the units described above may be realized by a dedicated hardware circuit.

Furthermore, programs to be executed by the control unit 60 of the embodiment described above may be stored on a computer connected, to a network such as the Internet, and may be provided as a computer program product by being downloaded via the network. Also, the programs to be executed by one control unit 60 of the embodiment described may be provided as a computer program product or distributed via a network such as the Internet. Moreover, the programs to be executed by the control unit 60 of the embodiment described may be provided as a computer program product, being embedded in a non-volatile recording medium such as a ROM or the like in advance.

Additionally, embodiments of the present invention have been described, bur the embodiments described above are presented only as examples, and are not intended to limit the scope of the invention. These new embodiments may be carried out in various other modes, and various omissions, replacements, and modifications are possible without departing from the spirit of the invention. These new embodiments and modifications fail within the scope and spirit of the invention, and also within the invention described in the accompanying claims and their equivalents.

Modification

In the following, modifications will be described.

(1) Modification 1

The first determination unit 63 may be configured, to determine, as at. least one capturing unit to be used for capturing an object, one of the first capturing unit 20 and the second capturing unit 30 which has captured an image in which the object is included.

For example, the first determination unit 63 acquires a captured image from each of the first capturing unit 20 and the second capturing unit 30, and performs a detection process on each of the two captured images acquired to detect whether or not the object is included in the captured images. Then, in the case presence of the object in only one of the captured images is detected, the first determination unit 63 may determine the capturing unit which has captured the captured image in which the object is included as the capturing unit to be used for capturing the object. That is, a configuration is possible where in the case the object is detected from one captured image but not from the other captured image, it is decided that the capturing unit, which has captured the captured image from which the object is not detected is highly possibly blocked by the hand of the viewer, and the capturing unit which is highly possibly not blocked by the hand of the viewer (the capturing unit which has captured the captured image from which the object is detected) is determined as the capturing unit to be used for capturing the object.

(2) Modification 2

Furthermore, the first determination unit 63 may be configured to determine, in the case the brightness value of the captured image of the first capturing unit 20 is greater than the brightness value of the captured image of the second capturing unit 30, the first capturing unit 20 as at least one capturing unit to be used for capturing an object, and to determine, in the case the brightness value of the captured image of the second capturing unit 30 is greater than the brightness value of the captured image of the first capturing unit 20, the second capturing unit 30 as at least one capturing unit to be used for capturing an object.

For example, in the case the average value of the brightness values of pixels induced in the captured image of the first capturing unit 20 is greater than the average value of the brightness values of pixels included in the captured image of the second capturing unit 30, the first determination unit 63 determines the first capturing unit 20 as the capturing unit, to be used for capturing an object, and in the case the average value of the brightness values of pixels included in the captured image of the second capturing unit 30 is greater than the average value of the brightness values of pixels included in the captured image of the first capturing unit 20, the first determination unit 63 determines the second capturing unit 30 as the capturing unit to be used for capturing an object. That is, a configuration is possible where in the case the brightness value of one captured image is greater than the brightness value of the other captured image, it is decided that the capturing unit which has captured the captured image with a smaller brightness value is highly possibly blocked by the hand of the viewer, and the capturing unit which is highly possibly not blocked by the hand of the viewer (the capturing unit which has captured the captured image with a greater brightness value) is determined as the capturing unit to be used for capturing the object.

(3) Modification 3

A configuration is possible where the captured image of the capturing unit which is the first capturing unit 20 or the second capturing unit 30 not determined (not selected) by the first determination unit 63 is used. For example, in the case the object is included in the captured image of the capturing unit not determined by the first determination unit 63, the estimation unit 65 described above may estimate the three-dimensional position of the object in the real space by a known triangulation method using the captured image of the capturing unit determined by the first determination unit 63 and the captured image of the capturing unit not determined. By using the captured image of the capturing unit not determined (not selected) by the first determination unit 63 in this manner, estimation of the three-dimensional position of the object, in the real space may be performed with a higher accuracy.

(4) Modification 4

Furthermore, although a portable stereoscopic image display device has been described as an example in the embodiments above, this is not restrictive, and the present invention may be applied to a portable display device capable of displaying a 2D image (a two-dimensional image), or a portable display device capable of switching between display of a 2D image and display of a 3D image (a stereoscopic image). In short, the display device according to the present invention may be in any configuration as long as it is a portable display device, and includes a display unit having a rectangular display screen for displaying an image, a first capturing unit arranged in a region, in the peripheral region of the display unit other than the display screen, corresponding to the first side of the display screen, the first capturing unit being for capturing an object, and a second capturing unit arranged in a region, in the peripheral region, corresponding to the second side adjacent to the first side, the second capturing unit being for capturing the object.

(5) Modification 5

Furthermore, the display control unit 67 described above may perform control of displaying, on the display unit 10, an image for the first side (an image for the long side) in the case the first angle indicating the angle between the reference line indicating the line segment connecting the eyes of a viewer, which are objects, and the first direction identified by the identification unit 62 is smaller than the second angle indicating the angle between the reference line and the second direction identified by the identification unit 62 (in the case the long side (the first side) of the display screen 11 is more parallel to the reference line than the short side (the second side) of the display screen 11). In this example, the display control unit 67 performs control of displaying, on the display unit 10, an image for the first side whose direction of parallax (the parallax direction) coincides with the first direction. Additionally, in this case, the control unit 60 controls the voltage of each electrode of the optical element 40 such that the liquid crystal GRIN lenses are periodically arranged along the first direction with the ridge line direction of each lens extending in a direction orthogonal to the first direction. For example, the function of controlling the voltage of each electrode of the optical element 40 may be included in the display control unit 67.

On the other hand, in the case the second angle is smaller than the first angle (in the case the snort side (the second side) of the display screen 11 is more parallel to the reference line than the long side (the first side) of the display screen 11), the display control unit 67 may perform control of displaying an image for the second side (an image for the short side) on the display unit 10. In this example, the display control unit 67 performs control of displaying, on the display unit 10, an image for the second side whose direction of parallax coincides with the second direction. Additionally, in this case, the control unit 60 (for example, the display control unit 67) controls the voltage of each electrode of the optical element 40 such that the liquid crystal GRIN lenses are periodically arranged, along the second direction with the ridge line direction extending in a direction orthogonal to the second direction. In this manner, according to the present modification, an image displayed on the display unit 10 is switched to an image which may be easily viewed by the viewer, according to the direction of the line segment, connecting the eyes of the viewer (the reference line), and thus, the convenience of the viewer may be further increased.

Additionally, the present modification may also be applied to a portable display device capable of displaying a 2D image. In short, any configuration is possible as long as a display control unit for displaying an image (a 3D image, a 2D image) on a display unit performs control of displaying an image for the first side on a display unit in the case the first angle is smaller than the second angle, and performs control of displaying an image for the second side on the display unit in the case the second angle is smaller than the first angle. Moreover, an image for the first side in the case of a 2D image, for example, is an image where at least the horizontal direction of the image to be viewed, coincides with the first, direction (the extending direction of the first side). Also, an image for the second side in the case of the 2D image, for example, is an image where at least the horizontal direction of the image to be viewed coincides with the second direction (the extending direction of the second side).

While certain embodiments have been described, these embodiments have been presented by way of example only and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A portable display device comprising:
a display unit including a rectangular display screen for displaying an image;
a first capturing unit configured to capture an image of an object, the first capturing unit being arranged in a region corresponding to a first side of the display screen, the region being a part of a peripheral region of the display unit other than the display screen; and
a second capturing unit configured to capture an image of the object, the second capturing unit being arranged in a region corresponding to a second side adjacent to the first side, the region being a part of the peripheral region.

2. The device according to claim 1, wherein the object includes eyes of a viewer of the portable display device, the device further comprising:
a detection unit configured to detect an attitude of the display device;
an identification unit configured to identify a first direction indicating an extending direction of the first side and a second direction indicating an extending direction of the second side, based on the attitude of the display device detected by the detection, unit; and
a determination unit configured to
determine the first capturing unit to be at least one of the first and second, capturing units to be used for capturing an image of the object when a first angle indicating an angle between a reference line and the first direction is smaller than, a second angle indicating an angle between the reference line and the second direction, and
determine the second capturing unit to be at least one of the first and second capturing units to be used for capturing an image of the object when the second angle is smaller than the first angle, the reference line indicating a line segment, connecting the eyes of a viewer.

3. The device according to claim 2, wherein the detection unit is a first detection unit, further comprising a second detection, unit configured to perform a detection process of detecting whether the object is present in the image captured by one of the first and second capturing units that has been determined to be the at least one of the first and second capturing units by the determination unit.

4. The device according to claim 3, further comprising an estimation unit configured to estimate a three-dimensional position of the object in a real space, based on object position information indicating a position and a size of the object detected by the detection process.

5. The device according to claim 4, wherein the determination unit is a first determination unit, the device further comprising:
a second determination unit configured to determine a visible area that allows the viewer to view a stereoscopic image so that the three-dimensional position estimated by the estimation unit is included in the visible area; and
a display control unit configured to control the display unit that displays the stereoscopic image so that the visible area determined by the second determination unit is formed.

6. The device according to claim 1, further comprising a determination unit configured to determine one of the first and second capturing units which has captured an image including the object, to be at least one of the capturing units used for capturing an image of the object.

7. The device according to claim 6, further comprising a detection unit configured to perform a detection process of detecting whether the object is present in the image captured by one of the first and second capturing units that has been determined to be the at least one of the capturing units by the determination unit.

8. The device according to claim 7, further comprising an estimation unit configured to estimate a three-dimensional position of the object in a real space, based on object position information indicating a position and a size of the object detected by the detection process.

9. The device according to claim 8, wherein the determination unit is a first determination unit, the device further comprising:
a second determination unit configured to determine a visible area that allows the viewer to view a stereoscopic image so that the three-dimensional position estimated by the estimation unit is included in the visible area; and
a display control unit configured to control the display unit that displays the stereoscopic image so that the visible area determined by the second determination unit is formed,

10. The device according to claim 1, further comprising a determination unit configured to
determine the first capturing unit to be at least one of the capturing units to be used for capturing an image of the object when a brightness value of an image captured by the first capturing unit is greater than a brightness value of an image captured by the second capturing unit, and
determine the second capturing unit to be at least one of the capturing units to be used for capturing an image of the object when the brightness value of the image captured by the second capturing unit is greater than the brightness value of the image captured by the first capturing unit.

11. The device according to claim 10, further comprising a detection unit configured to perform a detection process of detecting whether the object is present in the image captured by one of the first and second capturing units that has been determined to be the at least one of the capturing units by the determination unit.

12. The device according to claim 11, further comprising an estimation unit configured to estimate a three-dimensional position of the object in a real space, based on object position information indicating a position and a size of the object detected by the detection process.

13. The device according to claim 12, wherein the determination unit is a first determination unit, the device further comprising;
a second determination unit configured to determine a visible area that allows the viewer to view a stereoscopic image so that the three-dimensional position estimated by the estimation unit is included in the visible area; and
a display control unit configured to control the display unit that displays the stereoscopic image so that the visible area determined by the second determination unit is formed.

14. The display device according to claim 2, further comprising a display control unit configured to perform control to display the image on the display unit,
wherein the display control unit performs control to display an image for the first side on the display unit when the first angle is smaller than the second angle, and
the display control unit performs control to display an image for the second side on the display unit when the second angle is smaller than the first angle.
